(19) United States
(12) Patent Application Publication
(10) Pub. No.: US 2006/0126049 A1
(43) Pub. Date: Jun. 15, 2006

(54) Illumination system for a microlithography projection exposure apparatus

(75) Inventors: Markus Deguenther, Aalen (DE); Johannes Wangler, Koenigsbronn (DE); Markus Brotsack, Aalen (DE); Ella Mizkewitsch, Minsk (BY)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/271,844

(22) Filed: Nov. 14, 2005

Related U.S. Application Data
(63) Continuation of application No. PCT/EP04/04875, filed on May 7, 2004.

(30) Foreign Application Priority Data
May 12, 2003 (DE) 103 22 393.2

(51) Int. Cl. G03B 27/72

(52) U.S. Cl. 355/69; 355/53

(57) ABSTRACT

An illumination system for a microlithography projection exposure apparatus is designed for illuminating an illumination field with an illumination radiation with a predeterminable degree of coherence σ, it being possible to adjust the degree of coherence within a degree of coherence range extending into the range of very small degrees of coherence of significantly less than σ=0.2. The illumination system may have a first optical system for generating a predeterminable light distribution in an entrance plane of a light mixing device, and also a light mixing device for homogenizing the impinging radiation. The first optical system and the light mixing device can in each case be changed over between a plurality of configurations corresponding to different degree of coherence ranges. The degree of coherence ranges overlap and are dimensioned such that the resulting total degree of coherence range is larger than the individual degree of coherence ranges.

This application is a Continuation of International Patent Application PCT/EP2004/004875 filed on May 7, 2004, and claiming priority from German Patent Application DE 103 22 393.2 filed on May 12, 2003. Priority is claimed from German Patent Application DE 103 22 393.2 filed on May 12, 2003. The complete disclosure of these patent applications is incorporated into this application by reference.

### BACKGROUND OF THE INVENTION

1. Field of the Invention

The invention relates to an illumination system for a microlithography projection exposure apparatus for illuminating an illumination field with illumination radiation with a predeterminable degree of coherence.

2. Description of the Related Art

The performance of projection exposure apparatuses for the microlithographic fabrication of semiconductor components and other finely patterned devices is substantially determined by the imaging properties of the projection objectives. Furthermore, the image quality and the wafer throughput that can be achieved with the apparatus are substantially codetermined by properties of the illumination system arranged upstream of the projection objective. Said illumination system must be able to prepare the light from a primary light source, for example a laser, with the highest possible efficiency and in the process to generate an intensity distribution that is as uniform as possible in an illumination field of the illumination system. Moreover, it is intended to be possible to set different illumination modes at the illumination system in order, for example, to optimize the illumination in accordance with the structures of the individual originals to be imaged (masks, reticles). What are customary are setting possibilities between various conventional settings with different degrees of coherence σ and also annular field illumination and dipole or quadrupole illumination. The non-conventional illumination settings for generating an abaxial, oblique illumination may serve inter alia for increasing the depth of focus by two-beam interference and also by increasing the resolution.

EP 0 747 772 describes an illumination system comprising a zoom axicon objective, in the object plane of which is arranged a first diffractive raster element with a two-dimensional raster structure. This raster element serves for slightly increasing the light conductance of the impinging laser radiation through introduction of aperture and for altering the form of the light distribution in such a way as to produce, for example, an approximate circular distribution or a quadrupole distribution. For alternating between these illumination modes, if appropriate first raster elements are interchanged. A second raster element, which is situated in the exit pupil of the objective, is illuminated with the corresponding light distribution and shapes a rectangular light distribution, the form of which corresponds to the entrance surface of a downstream rod-type light mixing element (rod integrator). Through adjustment of the zoom axicon, it is possible to adjust the annularity of the illumination and the size of the illuminated region and thus the degree of coherence.

Such illumination systems are conventionally designed for a total degree of coherence range (setting range) of between approximately σ=0.25 and approximately σ=1. The degree of coherence σ is defined here as the ratio of the output-side numerical aperture of the illumination system to the input-side numerical aperture of a downstream projection objective.

For specific areas of application, it may be advantageous if even smaller degrees of coherence, for example from the range of between approximately 0.1 and 0.2 to 0.25, can be set. Such small degrees of coherence, which are also referred to here as “ultra small settings”, may be useful for example when using phase-shifting masks which are advantageously illuminated with light that is incident on the mask plane largely perpendicularly.

### SUMMARY OF THE INVENTION

It is one object of the invention to provide an illumination system for a microlithography projection exposure apparatus which permits the setting of very small degrees of coherence. It is another object to provide an illumination system for a microlithography projection exposure apparatus having the setting possibilities of conventional illumination systems which additionally can be extended to small degrees of coherence with a tenable constructional outlay essentially without any losses for the performance in the case of the illumination settings customary heretofore.

To address these and other objects, the invention, according to one formulation of the invention, provides an illumination system for a microlithography projection exposure apparatus comprising:

an adjustable optical system for receiving radiation from a radiation source and for illuminating an illumination field with illumination radiation with a predetermined degree of coherence, σ, chosen from a total degree of coherence range extending from a minimum degree of coherence, σₘᵢₙ, to a maximum degree of coherence, σₘₐₓ, with σₘᵢₙ≦σ≦σₘₐₓ,

wherein the total degree of coherence range includes a minimum degree of coherence, σₘᵢₙ, with σₘᵢₙ<0.2 and a maximum degree of coherence, σₘₐₓ, with 0.9≦σₘₐₓ≦1.

Advantageous developments are specified in the dependent claims. The wording of all the claims is incorporated in the content of the description by reference.

In an embodiment ultra small settings can be set where 0.1≦σₘᵢₙ≦0.15.

The adjustable optical system may include a first optical system for receiving light from the radiation source and for generating a predetermined radiation distribution in an entrance plane of a light mixing device, the light mixing device being designed for homogenizing the radiation coming from the first optical system and for outputting a homogenized radiation distribution in an exit plane of the light mixing device. The first optical system and the light mixing device may be assigned changeover devices for changing over the first optical system and the light mixing device between a first configuration associated with a first degree of coherence range and at least one second configuration associated with a second degree of coherence range, wherein the first degree of coherence range and the second degree of coherence range each are smaller than the total degree of coherence range and overlap partially such that the first degree of coherence range and the second degree of coherence range form the total degree of coherence range.

The first degree of coherence range may extend, for example, in a range (0.20-0.25)≦σ≦1, while the second degree of coherence range overlaps the first degree of coherence and may extend into the range of very small settings including σ values of σ=0.1 to 0.15.

According to another formulation of the invention, an illumination system according to the invention of the type mentioned in the introduction has a first optical system for receiving light from a light source and for generating a predeterminable light distribution in an entrance plane of a light mixing device, and also a light mixing device for homogenizing the radiation coming from the first optical system and for outputting a homogenized light distribution in an exit plane of the light mixing device. The first optical system and the light mixing device can in each case be changed over between a first configuration associated with a first degree of coherence range and at least one second configuration associated with a second degree of coherence range, the first and second degree of coherence ranges encompassing overall a total degree of coherence range that is larger than the first or the second degree of coherence range.

In this case, the total degree of coherence range preferably extends right into the range of ultra small σ values, for example with minimum settable degrees of coherence σₘᵢₙ in the range of approximately 0.1 to 0.15. The upper limit σₘₐₓ of the total degree of coherence range may correspond to that of conventional systems and lie for example at σ values of between 0.9 and 1.

In accordance with one aspect of the invention, the illumination system comprises two subsystems coordinated with one another, namely the first optical system and the light mixing device, which can in each case be altered by themselves in terms of their optical effect in a manner coordinated with one another, so that a larger total degree of coherence range can be covered in comparison with conventional systems, without impairing other parameters important for the illumination, such as, for example, the uniformity of the illumination of the illumination field.

In one embodiment, the first optical system is assigned at least one beam shaper alternating device with at least two different beam shaping elements which in each case contribute to the shaping of the radiation directed onto the entrance plane of the light mixing device and can optionally be introduced into the beam path of the first optical system for a changeover of the first optical system between the first configuration and the second configuration. In this case, preferably at least one of the beam shaping elements is an optical raster element with a two-dimensional raster structure. Advantageous embodiments of such raster elements are described in EP 0 747 772, for example, the disclosure content of which is incorporated in the content of this description by reference. Diffractive optical elements (DOE) may be involved, that is to say optical elements in the case of which the emitted radiation is shaped essentially by means of light diffraction (in contrast to light refraction). Refractive optical elements (ROE), for example elements with two-dimensional array arrangements of lenses, are also suitable as beam shaping elements.

A beam shaping element in the sense of this application is designed for transforming the impinging radiation into an emitted radiation having a predetermined angular distribution. Two-dimensional intensity distributions of the radiation with a predeterminable form can thus be set in a targeted manner in planes arranged at a distance behind such an element. In particular, such beam shaping elements are suitable for altering the geometric light conductance of the impinging radiation. The geometric light conductance, which is also referred to here as etendue is defined as the product of the numerical aperture of the radiation and the associated field size.

In a preferred embodiment, the first optical system has an objective with an object plane and an exit pupil, and the beam shaper alternating device is designed in such a way that the beam shaping elements can be inserted in the region of the exit pupil of the objective. The objective may contain a zoom objective, which may have a double to quadruple zoom range, for example. Such moderate zoom systems can be realized with a tenable constructional outlay. The objective may also contain an adjustable axicon pair, with which annular illuminations can optionally be generated. It is favorable if the axicon pair and the zoom system can be set independently of one another. The radiation distribution which can be set in a variable manner by means of the objective can be modified further by the interchangeable beam shaping elements downstream in order to be incident on the downstream light mixing device in a manner set in optimized fashion optionally for the different degree of coherence ranges.

In advantageous embodiments, the first optical system furthermore has at least one beam shaping element which is arranged or can be arranged in the region of the object surface of the objective and serves for altering the angular distribution of the radiation coming from the light source. This element may likewise be configured as an optical raster element with a two-dimensional raster structure and, in particular, as a diffractive optical element. If appropriate, these elements may also be interchangeable in order to accept a portion of the contributions—required for the changeover between different degree of coherence ranges—for influencing the light conductance.

In the changeover of the illumination system between different degree of coherence ranges, it is necessary, on the one hand, for the light conductance of the radiation that passes through to be influenced in a suitable manner, which can be achieved by the measures described above. On the other hand, there is the requirement for the illumination field to be illuminated as homogeneously as possible, which can be achieved through suitable homogenization or light mixing. In this case, the form and size of the illumination field is intended to vary as little as possible in different illumination modes. In order to enable an optimized light mixing for each degree of coherence range, the light mixing device of preferred embodiments has a first light mixing unit and at least one second light mixing unit and also a light mixer alternating device for optionally arranging the first light mixing unit or the second light mixing unit in the region of the optical axis of the light mixing device. Consequently, at least two differently designed light mixing units are available, the optical properties of which can be optimally adapted to the radiation shaped by the first optical system.

In order to enable a fast, automatic alternation between different light mixing units, the light mixing device of one preferred embodiment has a slide which can be displaced transversely with respect to the optical axis and on which the first and second light mixing units are mounted in such a way that they can optionally be moved into the region of the optical axis. It has been shown that a linear displacement that is possible as a result of this, during the alternation of the light mixing units, can be controlled with great accuracy and be performed very rapidly. As an alternative, turret alternating devices would be possible, by way of example.

It is favorable to provide a control device which enables a coordinated control of the beam shaper alternating device and the light mixer alternating device. The control device and the mechanical design of the alternating devices are in this case preferably configured in such a way that it is possible to carry out a changeover between a first configuration and a second configuration of the corresponding systems within a changeover time which essentially corresponds to the order of magnitude of a changeover time of the first optical system between different illumination settings. In some embodiments, the time for the alternation between the light mixing devices and the beam shaping elements may be of the order of magnitude of a few seconds. This means that, during operation of the projection exposure apparatus, no noticeable delay occurs if an operator performs on the equipment a setting which requires an alternation between the different configurations of the first optical system and the light mixing device.

In preferred embodiments, the first light mixing unit has at least one integrator rod having a first, preferably rectangular cross-sectional area and a first length, which is preferably dimensioned such that an entrance surface of the integrator rod can coincide with the entrance plane of the light mixing device and the exit surface of the integrator rod can coincide with the exit plane of the light mixing device. The cross-sectional area and the first length are in this case preferably dimensioned such that the integrator rod, in the first degree of coherence range, which encompasses the larger degrees of coherence that can also be obtained conventionally, in the case of the entrance angles of the radiation which occur in this case, reliably enables a sufficient number of internal (total) reflections which effect a good homogenization of the radiation. Compared with a possible alternative solution of a first light mixing unit with at least one fly's eye condenser, a light mixing unit with an integrator rod is distinguished, inter alia, by a reliable angular conservation of the impinging radiation and by a small structural size transversely with respect to the optical axis, which facilitates the provision of a plurality of different light mixing devices.

In one embodiment, the second light mixing unit has at least one second integrator rod having a second cross-sectional area and a second length, the second, preferably rectangular cross-sectional area being smaller than the first cross-sectional area and the second length being shorter than the first length. Provision is further made of an imaging system following the second integrator rod and serving for imaging an exit surface of the second integrator rod into the exit plane of the light mixing device. This light mixing unit may be dimensioned such that, on the one hand, it enables a sufficient light mixing in the case of the small numerical apertures required for the smaller degree of coherence range and, on the other hand, it generates an unaltered size of the illumination field.

In an alternative embodiment, the second light mixing unit has a fly's eye condenser arrangement with at least one fly's eye condenser. The fly's eye condenser arrangement may have, in the region of a surface that is Fourier-transformed with respect to the entrance plane of the light mixing device, a first raster arrangement with first raster elements for receiving the radiation coming from the entrance surface and for generating a raster arrangement of secondary light sources, and a second raster arrangement with second raster elements for receiving light from the secondary light sources and for at least partially superimposing light from the secondary light sources in the region of the exit plane of the light mixing device. Since this variant of a light mixing unit is preferably provided for the degree of coherence range with smallest degrees of coherence, where the illuminated surfaces in the region of the fly's eye condenser also have only small diameters, such light mixing devices can have a relatively small, slender structural size transversely with respect to the optical axis, which facilitates the incorporation into a light mixer alternating device.

In order to ensure a sufficient light mixing, the first and the second raster arrangement may in each case be formed by microlens arrays, which can be produced in a cost-effective manner lithographically, by way of example. The miniaturization makes it possible to ensure that a number of fully illuminated optical channels that suffices for a mixing is available even in the case of very small degrees of coherence and correspondingly small illuminated regions of the fly's eye condenser.

As an alternative or in addition, other measures may be provided in order to make the illumination system suitable for a total degree of coherence range extending from ultra small up to large settings, without significant losses in the overall performance, e.g. with regard to uniformity and ellipticity of the illumination.

In one variant, an integrator rod having a large cross section, the dimensions of which are optimized for a sufficient light mixing in the case of medium and large settings, may be used as a light mixer over said total degree of coherence range. If smaller settings, e.g. with minimum degrees of coherence Cmin in the range of approximately 0.1 to 0.15, are set e.g. by changing over the first optical system and/or by inserting an aperture-limiting diaphragm in a plane that is Fourier-transformed with respect to the reticle plane, then this may lead to a rod underfill and an associated pronounced parceling of the illumination pupil. This may result in unacceptable system properties. By way of example, the ellipticity over the field or the uniformity may assume values of several percent (uniformity=(max−min)/(max+min) of the intensity).

These problems can be reduced or avoided if at least one scattering element having suitable scattering angle distribution, for example a scattering screen or a diffractive optical element having a comparable effect, is inserted into the beam path behind the rod integrator, for example directly at the exit surface thereof or in a manner slightly offset axially with respect thereto. As a result, it is possible to achieve a “blurring” of the parceling, that is to say a homogenizing of the intensity distribution in the pupil. It has been shown that this makes it possible to reduce the abovementioned values for ellipticity and uniformity to approximately 20% to 30% of the values without a scattering element. The scattering element may optionally be fixedly installed or interchangeable. An interchangeable scattering element makes it possible to reconfigure the light mixing device between configurations associated with different degree of coherence ranges. With the use of such scattering elements, it is possible, if appropriate, to dispense with making the first optical system able to be changed over.

The above and further features emerge not only from the claims but also from the description and from the drawings, in which case the individual features may be realized, and may represent advantageous embodiments protectable per se, in each case on their own or as a plurality in the form of subcombinations in an embodiment of the invention and in other fields.

### BRIEF DESCRIPTION OF THE DRAWINGS

FIG. 1 shows a schematic overview of an embodiment of an illumination system according to the invention for a microlithography projection exposure apparatus;

FIG. 2 shows a schematic perspective illustration of an embodiment of a light mixing device with a slide that can be moved transversely with respect to the optical axis;

FIG. 3 shows a first embodiment of a second light mixing unit optimized for small degrees of coherence; and

FIG. 4 shows a second embodiment of a second light mixing unit optimized for small degrees of coherence.

### DETAILED DESCRIPTION OF THE PREFERRED EMBODIMENTS

FIG. 1 shows an example of an illumination system 1 of a microlithographic projection exposure apparatus which can be used in the fabrication of semiconductor components and other finely patterned devices and operates with light from the deep ultraviolet range in order to obtain resolutions down to fractions of micrometers. The light source 2 used is an F₂ excimer laser having an operating wavelength of approximately 157 nm, the light beam of which is oriented coaxially with respect to the optical axis 3 of the illumination system. Other UV light sources, for example ArF excimer lasers having an operating wavelength of 193 nm, KrF excimer lasers having an operating wavelength of 248 nm or mercury vapor lamps having an operating wavelength of 368 nm or 436 nm or light sources having wavelengths of less than 157 nm are likewise possible.

The light from the light source 2 firstly enters a beam expander 4, which may be designed for example as a mirror arrangement in accordance with DE 41 24 311 and serves for coherence reduction and enlargement of the beam cross section. In the case of the embodiment shown, an optionally provided shutter is replaced by a corresponding pulsed control of the laser 2.

A first diffractive optical raster element 5 serving as a beam shaping element is arranged in the object plane 6 of an objective 7 arranged behind this in the beam path, a refractive second optical raster element 9, which likewise serves as a beam shaping element, being arranged in the image plane 8 or exit pupil of said objective.

A coupling-in optic 10 arranged behind this transmits the light onto the entrance plane 11 of a light mixing device 12, which mixes and homogenizes the light passing through. An intermediate field plane lies directly at the exit plane 13 of the light mixing device 12, in which intermediate field plane is arranged a reticle/masking system (REMA) 14, which serves as an adjustable field diaphragm. The downstream objective 15 images the intermediate field plane with the masking system 14 onto reticles 16 (mask, lithography original) and contains a first lens group 17, a pupil intermediate plane 18, into which filters or diaphragms can be introduced, a second and a third lens group 19 and 20, respectively, and a deflection mirror 21 in between, which mirror makes it possible to incorporate the large illumination device (length approximately 3 m) horizontally and to mount the reticle 16 horizontally.

This illumination system forms together with a projection objective (not shown) and an adjustable wafer holder, which holds the reticle 16 in the object plane of the projection objective, a projection exposure apparatus for the microlithographic fabrication of electronic devices but also of optically diffractive elements and other micropatterned parts.

The optical elements or assemblies 4, 5, 7, 9 or 9′ and 10 between the light source and the light mixing device form a first optical system 30 for receiving light from the light source 2 and for generating a predeterminable light distribution in the entrance plane of the light mixing device.

The embodiment of the parts situated upstream of the light mixing device 12, in particular of the optical raster elements 5 and 9, is chosen such that a rectangular entrance surface of the light mixing device is illuminated largely homogeneously and with the highest possible efficiency, that is to say without substantial light losses alongside the entrance surface. For this purpose, the parallel light beam coming from the beam expander 4 and having a rectangular cross section and a non-rotationally symmetrical divergence is firstly altered with regard to divergence and form by means of the first diffractive raster element 5 with the introduction of light conductance. In particular, the first raster element 5 has a multiplicity of hexagonal cells that generate an angular distribution of this form. The numerical aperture of the first diffractive raster element is NA=0.025 in this case, whereby approximately 10% of the total light conductance to be introduced is introduced. Elements that introduce an aperture from the range 0.020≦NA≦0.027 are generally preferred. In the case of significantly smaller apertures, there is the risk of possible divergence asymmetries of the incident radiation becoming apparent in a disturbing fashion in the exit-side angular distribution. Significantly larger apertures may lead to an overfilling of the rod entrance and thus to light losses.

The first optical raster element 5 arranged in the front focal plane (object plane) of the zoom optic 7 prepares, together with the focal length zoom optic 7, an illumination spot having a variable size in the exit pupil or image plane 8 of the zoom system. The second optical raster element 9 is arranged here, which raster element is designed as a refractive optical element with a rectangular emission characteristic in the example. This beam shaping element generates the main proportion of the light conductance and adapts the light conductance to the field size, that is to say to the rectangular form of the entrance surface of the light mixing device 12, by means of the coupling-in optic 10.

The construction of the illumination system described up to this point with the exception of the light mixing device may correspond for example to the construction described in EP 0 747 772, the disclosure content of which is in this respect incorporated in the content of this description by reference.

In conventional systems of this type, an individual integrator rod made of transparent optical material, for example calcium fluoride, was provided as light mixing device 12, which integrator rod mixes and homogenizes the radiation passing through by means of multiple internal reflection. It was thus possible to cover a total degree of coherence range with a values between approximately 0.2 to 0.25 and approximately 1 in a continuously variable manner. By comparison, illumination systems according to the invention are distinguished by a total degree of coherence range extending into the range of ultra small settings, for example to σ values of σ=0.1 to 0.15.

It has been found that such a reduction of the smallest σ value that can be set, whilst at the same time maintaining the optical system performance, cannot be achieved or can only be achieved with losses in performance by interchanging the first optical raster elements 5 serving for pupil filling. In the embodiment shown, other constructional modifications that can be realized with a tenable constructional outlay by comparison with conventional systems are realized in order to permit the available degree of coherence range to be extended to lower σ values.

Firstly, the first optical system 30 is assigned a beam shaper alternating device 40, which makes it possible to interchange the beam shaping elements 9 which serve for illuminating the field at the entrance of the light mixing device. Two differently designed optical raster elements 9, 9′ are provided in the example, which raster elements can optionally be inserted into the beam path behind the objective 7 in the region of the exit pupil thereof. In this case, by way of example, the beam shaping element 9 may have a larger output-side numerical aperture than the raster element 9′, which is provided for smaller σ values. However, a reduction of the numerical aperture of the beam shaping element 9 by itself normally does not suffice to achieve the range of very small σ values without losses in optical performance. A reduction of the numerical aperture of the beam shaping elements 9 by itself would initially lead only to a reduction of the area illuminated at the entrance of the light mixing device. In the exit plane 13 or the reticle plane itself which is optically conjugate with respect thereto, the field size would remain unchanged. However, light-free regions in the illumination pupil would be enlarged on account of a rod underfill (parceling of the pupil).

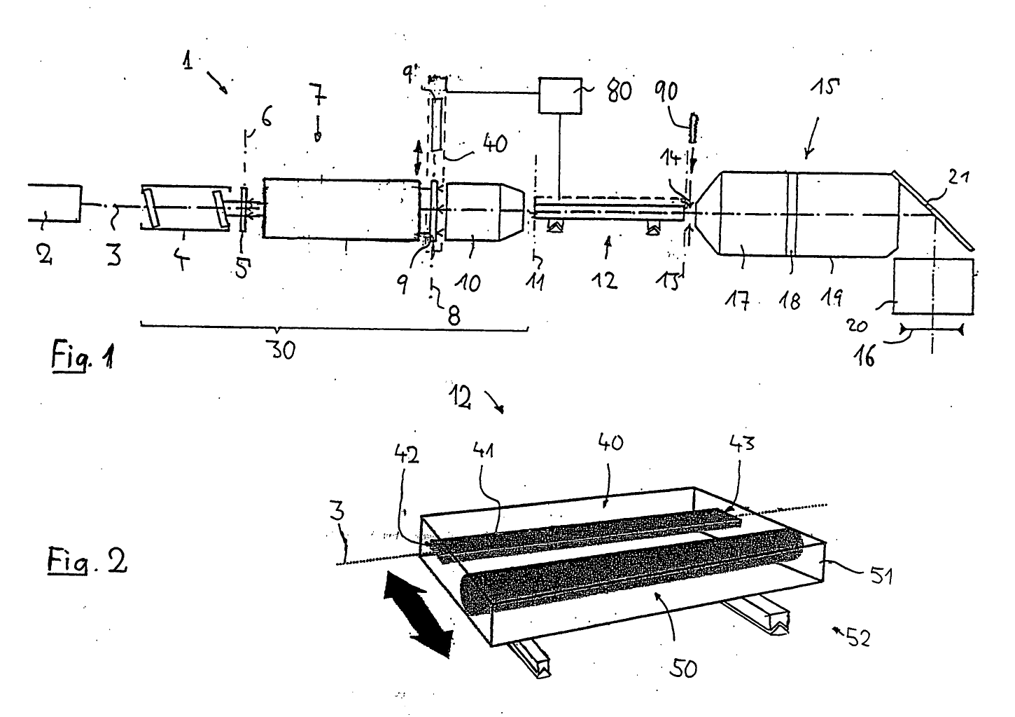

In the embodiment shown, a changeover to small σ values without such losses of performance is possible by virtue of the fact that the light mixing device 12 can be changed over between two configurations, the first configuration corresponding to a first degree of coherence range (for example the degree of coherence range that can be achieved conventionally (0.20-0.25)<σ<1), while the second degree of coherence range overlaps the first degree of coherence and extends into the range of very small settings. As illustrated schematically in FIG. 2, the light mixing device 12 has two light mixing units 40, 50 which operate independently of one another and are arranged in a common mount 51 parallel to one another and to the optical axis 3 and can optionally be moved into the region of the optical axis 3 transversely with respect to the optical axis with the aid of a slide 52.

In this case, the first light mixing unit 40 is formed by an integrator rod 41, the dimensions of which may correspond to those of the integrator rod of a comparable conventional illumination device. In particular, the integrator rod 41 has a length measured between the rectangular entrance surface 42 and the rectangular exit surface 43 which corresponds to the distance between the entrance plane and the exit plane of the light mixing device 12. If the light mixing device is operated in a first configuration corresponding to the degree of coherence range having larger σ values, then this large light mixing rod can be centered about the optical axis, so that its entrance surface coincides with the entrance plane and its exit surface coincides with the exit plane of the light mixing device. If smaller σ values are required, then the integrator rod 40 can be moved out from the region of the optical axis 3 by movement of the slide and the second light mixing unit 50, which is optimized for smaller σ values, can be moved in the region of the optical axis.

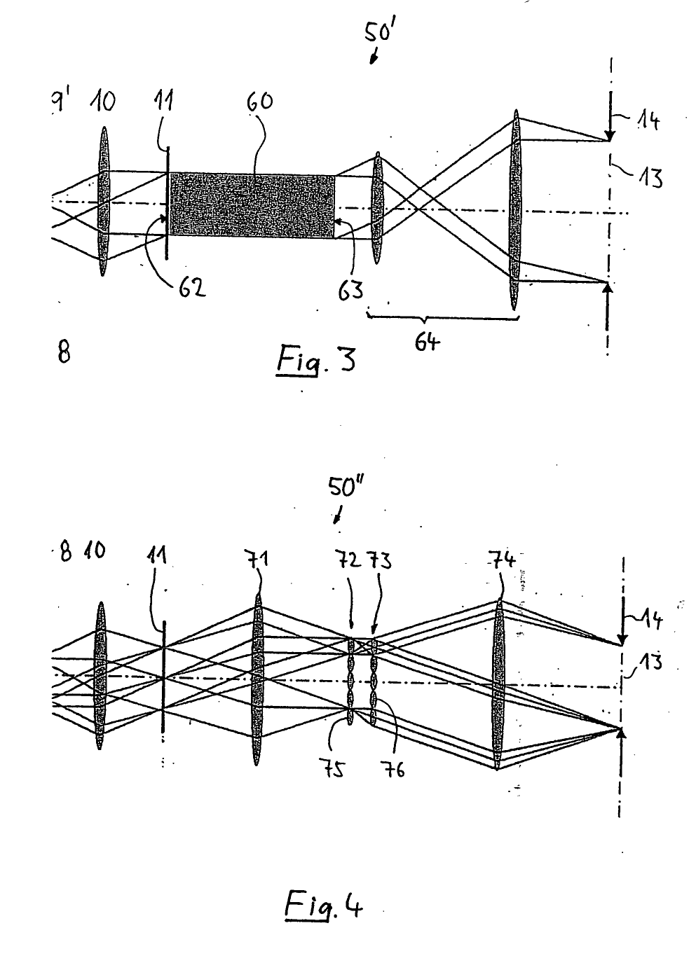

In the case of an embodiment explained in association with FIG. 3, the second light mixing unit 50′ has a second integrator rod 60, the cross section and length of which are reduced by comparison with the first integrator rod 41. In this case, the dimensions of the shorter and more slender integrator rod 60 are designed such that the integrator rod is well filled despite the lower numerical aperture of the associated beam shaping element 9′ arranged upstream. In this case the rectangular cross section is dimensioned such that it substantially corresponds to the field size generated by the associated raster element 9′ in the entrance plane 11 of the light mixing device. As a result, an underfill of the integrator rod 60, which leads to a parceling of the illumination pupil, or an overfill leading to light losses can be sufficiently limited or avoided. Furthermore, on account of the reduced cross section, the homogenization in the rod, determined by the number of reflections at the lateral side surfaces, is provided to a sufficient extent despite the shortened length.

Arranged behind the integrator rod 60 is an afocal imaging optic 64, which projects the rod exit 63 with an adapted imaging scale into the exit plane 14 of this light mixing unit or into a plane that is slightly defocused with respect thereto. In this case, that size of the rectangular illumination field which is also achieved in the case of the larger integrator rod 41 is generated in the exit plane 14 of the light mixing device by suitable magnification of the imaging optic 63 for example by a factor in the region of 2. The magnifying imaging scale of the imaging optic 64 accordingly corresponds to the size relationship between the cross sections of the long integrator rod 41 and of the short integrator rod 60. Since the light conductance is maintained during this imaging of the rod exit 63 into the exit plane 14 of the light mixing device, the numerical aperture of the radiation, and hence its σ value, is correspondingly reduced during the magnification. Consequently, in this embodiment, through the exchange of the raster element 9′ provided for small σ values, essentially the size of the region illuminated in the entrance surface of the light mixing device is reduced, while the numerical aperture is reduced essentially during the magnified imaging of the rod exit 63 into the exit plane 14 of the light mixing device.

Another embodiment of a second light mixing unit 50″ is explained in more detail in connection with FIG. 4. This light mixing unit may be mounted, as an alternative to the light mixing unit shown in FIG. 3, on the slide 52 alongside the first light mixing unit formed by the large rod integrator 41. The light mixing unit 50″ is configured as a fly's eye condenser arrangement (fly eyes integrator). It comprises a condenser lens 71, a raster arrangement 72 of first raster elements arranged at a distance behind the latter, a raster arrangement 73 of second raster elements arranged behind the latter, and a field lens 74 arranged at a distance behind the latter. In this case, the first raster arrangement 72 lies at a distance of 2f behind the entrance plane 11 of the light mixing device, where f is the focal length of the condenser lens 71. As a result, the first raster arrangement 72 lies in a plane that is Fourier-transformed with respect to the entrance plane 11. In the case of the multistage construction of the fly's eye condenser, the first raster arrangement 72 generates from the incident light a raster arrangement of secondary light sources, the number of which corresponds to the number of illuminated first raster elements 75. The form of the first raster elements is intended essentially to correspond to the form of the field to be illuminated in the exit plane 13 of the light mixing device. Therefore, they are also referred to as field honeycombs and are rectangular in the case of the example. The downstream second raster arrangement 73 serves for imaging the first raster element 75 into the illumination surface 13 containing the illumination field, and in the process for superimposing the light from the secondary light sources in the illumination field. A light mixing is thereby achieved. The second raster elements 76 are often referred to as pupil honeycombs. In the embodiment, the first and second raster elements are assigned to one another in pairs and form a number of optical channels whose different light intensities are superimposed in the illumination field in the sense of a homogenization of the intensity distribution with the aid of the field lens 74.

Since this embodiment of the second light mixing unit 50″ is preferably provided for the second degree of coherence range having small σ values and, accordingly, the beam cross section in the region of the light mixing unit is relatively small, the diameters of all the optical components of the fly's eye condenser light mixing device 50″ can be kept small, thus enabling an interchange with an approximately identically dimensioned rod integrator without any substantial modifications to the installation environment. The fly's eye condenser can be produced from two microlens arrays 72, 73, with the result that a good light intermixing can be achieved even in the case of illuminated surfaces having only small diameters by means of an illumination of a sufficient number of “optical channels”.

The beam shaper alternating device 40 and the light mixing device 12 are controlled by a common control device 80, which coordinates the interchange of the raster elements 9 of the first optical system 30 and the alternation between different light mixing units in such a way that, for each light distribution provided by the optical system 30, in the entrance plane 11 of the light mixing device, the correspondingly adapted light mixing unit is provided in a positionally correct manner with high positioning accuracy by movement of the slide 52 in a short time, usually within a few seconds.

One essential advantage of this and comparable embodiments of the invention is that the insertion of the embodiments shown in FIG. 3 or FIG. 4 or of comparable arrangements does not require a complete optical or mechanical redesign of the illumination device. Rather, it is possible to modify existing illumination systems of the type described in the introduction by incorporating corresponding alternating devices for the raster elements 9, 9′ and the light mixing device, and also for the raster elements 5, if appropriate, in such a way that the range of very small σ values can also be set. It is thus possible optionally to provide systems with or without the possibility of obtaining ultra small σ values on the basis of an illumination system platform depending on the requirements of the end user.

In a variant which is not illustrated pictorially and which operates without a slide 52 and interchangeable light mixing units, one and the same integrator rod (cf. rod 41) having a large cross section can be used as a light mixer both in the case of large settings of conventional systems and in the case of ultra small σ values. If ultra small settings are set e.g. by changing of the first optical system and/or by inserting an aperture-limiting diaphragm in a plane 18 (pupil plane of the ReMa objective 15) that is Fourier-transformed with respect to the reticle plane, then this may lead to a rod underfill and an associated pronounced parceling of the illumination pupil. This may result in unacceptable system properties with regard to ellipticity over the field or uniformity.

These problems can be reduced or avoided by virtue of at least one scattering element having a suitable scattering angle distribution, for example a scattering screen 90 (FIG. 1) or a diffractive optical element having a comparable effect, being inserted into the beam path behind the rod integrator, for example directly at the exit surface thereof or in a manner slightly offset axially with respect thereto. As a result, it is possible to achieve a “blurring” of the parceling, that is to say a homogenizing of the intensity distribution in the pupil. The scattering screen may be fixedly installed or inter-changeable; if appropriate, it may also be inserted between the ReMa blades 14 and the entrance of the objective 15.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. An illumination system for a microlithography projection exposure apparatus comprising:
an adjustable optical system receiving radiation from a radiation source and illuminating an illumination field with illumination radiation with a predetermined degree of coherence, σ, chosen from a total degree of coherence range extending from a minimum degree of coherence, σₘᵢₙ, to a maximum degree of coherence, σₘₐₓ, with σₘᵢₙ≦σ≦σₘₐₓ,
wherein the total degree of coherence range includes a minimum degree of coherence with σₘᵢₙ<0.2 and a maximum degree of coherence with 0.9≦σₘₐₓ≦1.

2. An illumination system according to claim 1, wherein 0.1≦σₘᵢₙ≦0.15.

3. An illumination system according to claim 1, wherein the adjustable optical system comprises:
a first optical system receiving light from the radiation source and generating a predetermined radiation distribution in an entrance plane of a light mixing device;
the light mixing for homogenizing the radiation from the first optical system and for outputting a homogenized radiation distribution in an exit plane of the light mixing device;
changeover devices changing over the first optical system and the light mixing device between a first configuration associated with a first degree of coherence range and at least one second configuration associated with a second degree of coherence range;
wherein the first degree of coherence range and the second degree of coherence range each are smaller than the total degree of coherence range and overlap partially such that the first degree of coherence range and the second degree of coherence range form the total degree of coherence range.

4. An illumination system according to claim 3, wherein the first degree of coherence range extends in a range (0.20-0.25)≦σ≦1, while the second degree of coherence range overlaps the first degree of coherence range and extends into the range of very small settings including σ values of σ=0.1 to 0.15.

5. The illumination system as claimed in claim 3, wherein the first optical system is assigned at least one beam shaper alternating device with at least two beam shaping elements, which contribute to the shaping of the radiation directed onto the entrance plane of the light mixing device and configured to be introduced into the beam path of the first optical system.

6. The illumination system as claimed in claim 5, wherein the first optical system has an objective with an object plane and an exit pupil, and the beam shaper alternating device is set up such that the beam shaping elements can be inserted in the region of the exit pupil of the objective.

7. The illumination system as claimed in claim 3, wherein the first optical system comprises a zoom system.

8. The illumination system as claimed in claim 3, wherein the first optical system comprises an adjustable axicon pair for optionally setting annular illuminations.

9. The illumination system as claimed in claim 3, wherein the first optical system has at least one beam shaping element arranged in the region of an object plane of an objective and configured to alter the angular distribution of the radiation coming from the light source, and an alternating device is provided for interchangeing different beam shaping elements.

10. The illumination system as claimed in claim 9, wherein the beam shaping element is a diffractive optical element.

11. The illumination system as claimed in claim 3, wherein the light mixing device comprises a first light mixing unit and at least one second light mixing unit and a light mixer alternating device configured to optionally arrange the first light mixing unit or the second light mixing unit in the region of an optical axis of the light mixing device.

12. The illumination system as claimed in claim 11, wherein the light mixer alternating device has a slide configured to move transversely with respect to the optical axis and on which the first light mixing unit and the second light mixing unit are mounted such that they can optionally be moved into the region of the optical axis by movement of the slide.

13. The illumination system as claimed in claim 11, wherein the first light mixing unit has at least one integrator rod having a first cross-sectional area and a first length, the first length being dimensioned such that an entrance surface of the integrator rod can be arranged in the region of the entrance plane and an exit surface of the integrator rod can be arranged in the region of the exit plane of the light mixing device, and the second light mixing unit has at least one second integrator rod having a second cross-sectional area and a second length, the second cross-sectional area being smaller than the first cross-sectional area and the second length being shorter than the first length, and further comprising an imaging system following the second integrator rod and serving for imaging the exit surface of the second integrator rod into the exit plane of the light mixing device.

14. The illumination system as claimed in claim 11, wherein the second light mixing unit comprises a fly's eye condenser arrangement with at least one fly's eye condenser.

15. The illumination system as claimed in claim 1, further comprising a control device for a coordinated control of a beam shaper alternating device with at least two beam shaping elements, which contribute to the shaping of radiation directed onto an entrance plane of a light mixing device and configured to be introduced into the beam path of the first optical system, and a light mixer alternating device configured to optionally arrange a first light mixing unit or a second light mixing unit in the region of an optical axis of a light mixing device.

15. The illumination system as claimed in claim 1, further comprising at least one scattering element, which is configured to be arranged optically downstream of an integrator rod of a light mixing device.

16. An illumination system for a microlithography projection exposure apparatus for illuminating an illumination field with illumination radiation with a predeterminable degree of coherence, comprising:
a first optical system configured to receive light from a light source and to generate a predeterminable light distribution in an entrance plane of a light mixing device;
a light mixing device configured to homogenize the radiation from the first optical system and output a homogenized light distribution in an exit plane of the light mixing device;
the first optical system and the light mixing device being configured to be changed over between a first configuration associated with a first degree of coherence range and at least one second configuration associated with a second degree of coherence range, and the first and second degree of coherence ranges encompassing a total degree of coherence range that is larger than the first or the second degree of coherence range.

17. The illumination system as claimed in claim 16, wherein the total degree of coherence range encompasses minimum degrees of coherence σₘᵢₙ of less than 0.2.

18. The illumination system as claimed in claim 17, wherein σₘᵢₙ lies between approximately 0.1 and approximately 0.15.

19. The illumination system as claimed in claim 16, wherein the first optical system is assigned at least one beam shaper alternating device with at least two beam shaping elements which contribute to the shaping of the radiation directed onto the entrance plane of the light mixing device and which are configured to be optionally introduced into the beam path of the first optical system.

20. The illumination system as claimed in claim 19, wherein at least one of the beam shaping elements is an optical raster element with a two-dimensional raster structure.

21. The illumination system as claimed in claim 19, wherein the first optical system has an objective with an object plane and an exit pupil, and the beam shaper alternating device is configured to insert the beam shaping elements in the region of the exit pupil of the objective.

22. The illumination system as claimed in claim 21, wherein the objective contains a zoom system.

23. The illumination system as claimed in claim 21, wherein the objective contains an adjustable axicon pair optionally setting annular illuminations.

24. The illumination system as claimed in claim 16, wherein the first optical system has at least one beam shaping element arranged in the region of an object plane of an objective and configured to alter the angular distribution of the radiation coming from the light source.

25. The illumination system as claimed in claim 24, wherein the beam shaping element is a diffractive optical element.

26. The illumination system as claimed in claim 24, further comprising an alternating device configured to interchange different beam shaping elements.

27. The illumination system as claimed in claim 16, wherein the light mixing device comprises a first light mixing unit, at least one second light mixing unit and a light mixer alternating device configured to optionally arrange the first light mixing unit or the second light mixing unit in the region of an optical axis of the light mixing device.

28. The illumination system as claimed in claim 27, wherein the light mixer alternating device has a slide which is configured to move transversely with respect to the optical axis and on which the first light mixing unit and the second light mixing unit are mounted such that they can optionally be moved into the region of the optical axis by movement of the slide.

29. The illumination system as claimed in claim 27, wherein the first light mixing unit has at least one integrator rod having a first cross-sectional area and a first length, the first length being dimensioned such that an entrance surface of the integrator rod can be arranged in the region of the entrance plane and an exit surface of the integrator rod can be arranged in the region of the exit plane of the light mixing device.

30. The illumination system as claimed in claim 27, wherein the second light mixing unit has at least one second integrator rod having a second cross-sectional area and a second length, the second cross-sectional area being smaller than the first cross-sectional area and the second length being shorter than the first length, and further comprising an imaging system following the second integrator rod and configured to image the exit surface of the second integrator rod into the exit plane of the light mixing device.

31. The illumination system as claimed in claim 30, wherein the imaging system has a magnified imaging scale.

32. The illumination system as claimed in claim 30, wherein the imaging system has an imaging scale that corresponds to a size relationship between the size of the exit surface of the first integrator rod and the size of the exit surface of the second integrator rod.

33. The illumination system as claimed in claim 30, wherein the second light mixing unit comprises a fly's eye condenser arrangement with at least one fly's eye condenser.

34. The illumination system as claimed in claim 33, wherein the fly's eye condenser arrangement has, in the region of a plane that is Fourier-transformed with respect to the entrance plane of the light mixing unit, a first raster arrangement with first raster elements configured to receive the radiation from the entrance surface and to generate a raster arrangement of secondary light sources, and a second raster arrangement with a second raster element configured to receive and at least partially to superimpose light from the secondary light sources in the region of the exit plane of the light mixing unit.

35. The illumination system as claimed in claim 34, wherein the fly's eye condenser arrangement has at least one microlens array.

36. The illumination system as claimed in claim 16, further comprising a control device configured to control a beam shaper alternating device and a light mixer alternating device in a coordinated manner.

37. The illumination system as claimed in claim 36, wherein the control device and the alternating devices are configured to carry out an alternation between a first and a second configuration of the illumination system within a changeover time which is of the order of magnitude of a changeover time of the first optical system for an alternation between different illumination settings.

38. The illumination system as claimed in claim 16, which is assigned at least one scattering element, configured to be arranged behind an integrator rod.

39. The illumination system as claimed in claim 38, wherein the scattering element is configured to be arranged in the region of the exit axis.

40. An illumination system for a microlithography projection exposure apparatus for illuminating an illumination field with illumination radiation with a predeterminable degree of coherence, comprising:
a first optical system for receiving light from a light source and for generating a predeterminable light distribution in an entrance plane of a light mixing device;
a light mixing device for homogenizing the radiation coming from the first optical system and for outputting a homogenized light distribution in an exit plane of the light mixing device; and
at least one scattering element, which is arranged or can be arranged in the region of the exit plane or behind the exit plane.

41. The illumination system as claimed in claim 40, wherein the light mixing device has an integrator rod having a first cross-sectional area and a first length, the first length being dimensioned such that an entrance surface of the integrator rod is arranged in the region of the entrance plane and an exit surface of the integrator rod is arranged in the region of the exit plane of the light mixing device.
